(19) United States
(12) Patent Application Publication
(10) Pub. No.: US 2026/0087570 A1
(43) Pub. Date: Mar. 26, 2026

(54) PERSONALIZED PROPERTY TOUR AND LEAD SCORING SYSTEM, METHODS, AND APPARATUS

(71) Applicant: Keller Williams Realty, LLC, Austin, TX (US)

(72) Inventors: Kaiser H.D. Kabir, Austin, TX (US); John Keller, Austin, TX (US); Mark Nicholas Law, Leander, TX (US)

(73) Assignee: Keller Williams Realty, LLC, Austin, TX (US)

(21) Appl. No.: 19/398,534

(22) Filed: Nov. 24, 2025

Related U.S. Application Data
(62) Division of application No. 17/713,751, filed on Apr. 5, 2022.
(60) Provisional application No. 63/171,876, filed on Apr. 7, 2021.

(51) Int. Cl. G06Q 50/16; G06Q 30/0282; G06Q 30/0601

(52) U.S. Cl. CPC G06Q 50/16; G06Q 30/0643; G06Q 30/0282

(57) ABSTRACT

A system and method for generating and providing personalized virtual property tours are disclosed. In some examples, a system provides a virtual property tour that is displayed within an application or a web browser as an interactive open house experience. The virtual property tour enables a user to view an open house virtually through a display of a floor plan, photos of rooms, videos of rooms, three-dimensional tours of rooms, and/or a virtual interactive engagement with rooms. In some embodiments, the virtual property tour is user-directed by selecting a room or other location from a virtual floor plan. In other embodiments, the virtual property tour is configured as an automated progression through a property

### PRIORITY CLAIM

This application is a divisional of U.S. application Ser. No. 17/713,751, filed Apr. 5, 2022, and claims priority to and the benefit as a non-provisional application of U.S. Provisional Patent Application No. 63/171,876, filed Apr. 7, 2021, the entire contents of which are hereby incorporated by reference and relied upon.

### BACKGROUND OF THE INVENTION

Many people today often take online real estate websites and mobile applications for granted. These digital products, services, and destinations typically show available homes for sale or rent within a specific geographic area, such as a zip code or town. Some real estate digital products even provide estimated prices for homes. Before these digital products, the only way to locate available real estate was through printed magazines/newspapers, real estate agents, or word of mouth.

Known real estate digital products are buyer-agnostic. For instance, these known real estate digital products are concerned with property valuations and the display of housing information. Indeed, these known websites and mobile applications are often static in that the same real estate information is presented to all of the buyers. Of course, some digital products allow a buyer to filter real estate criteria, and even some digital products permit a buyer to filter their search criteria. However, such searches only narrow down the static information rather than specifically personalizing and/or tailoring the information to the buyer and dynamically updating the information based on learned characteristics of the buyer.

Another known issue with the current real estate framework relates to open houses. Oftentimes, agents collect contact information from individuals that attend an open house. The agents then have to spend time contacting the individuals to gauge their interest in the property. However, much of this time is wasted effort if the individuals are not serious buyers. Further, most individuals provide scant feedback after an open house, even after an agent has followed up.

A need accordingly exists for digitizing open houses to improve the targeting of prospective buyers and obtain valuable feedback for home sellers.

### SUMMARY OF THE INVENTION

Methods, apparatus, and systems are disclosed for providing an interactive open house experience. The interactive open house experience may be embodied in one or more applications (e.g., apps) on a smartphone or other portable user device. The methods, apparatus, and systems enable users to view an open house virtually through a display of a floor plan, photos of rooms, videos of rooms, three-dimensional tours of rooms, and/or a virtual interactive engagement with rooms. In some embodiments, the virtual property tour provided by the example methods, apparatus, and systems is user-directed by selecting a room or other location from a virtual floor plan. In other embodiments, the virtual property tour provided by the example methods, apparatus, and systems is configured as an automated progression. In some embodiments, the methods, apparatus, and systems determine the automated progression while in other instances the progression may be defined by a listing agent.

In addition to enabling a user view a property tour virtually, the example methods, apparatus, and systems are configured to provide an automated guide for in-person tours. A user may select a room from a virtual property tour while physically standing in the same room to learn more information about the property. In some instances, the example methods, apparatus, and systems use satellite and/or terrestrial positioning signals to determine where a user is located with respect to a particular room or property location. Additionally or alternatively, the example methods, apparatus, and systems may use dead reckoning sensors such as gyroscopes and/or accelerometers integrated into a user device to determine their location in a property relative to a floor plan. The example methods, apparatus, and systems are configured to then display information (e.g., audio, video, virtual interactive features, text, etc.) of the appropriate room or property location.

The example methods, apparatus, and systems are configured to use the virtual property tour to obtain feedback from a user. During a property tour, the methods, apparatus, and systems are configured to provide prompts that enable a user to easily leave feedback for a property generally, specific rooms, and/or individual photos or videos. The prompts may include like/dislike icons and/or text boxes that enable a user to enter comments. Feedback may also be acquired based on a length of time a user has viewed a room. In some instances, the methods, apparatus, and systems may combine feedback from a user with obtained demographic information and/or profile information to determine whether the user is a likely buyer, a potential buyer, a moderate buyer, a not interested buyer, or not a buyer at all. The methods, apparatus, and systems are configured to rank buyers based on a likely match or interest in the property, which a listing agent may use to chase the most likely buyer candidates.

The example methods, apparatus, and systems are also configured to provide feedback to property sellers regarding certain features that prospective buyers like or hate. For example, with enough feedback, a listing agent can show a property seller that wall colors in the kitchen and living room are creating a significant negative impression with potential buyers. As a result, the property seller may have those rooms repainted to improve property marketability and ultimately, the property selling price.

The example methods, apparatus, and systems are also configured to create a user account to enable access to the virtual property tours. User registration with a virtual account provides visibility into an identity of users that view and provide feedback regarding property listings. Further, the example methods, apparatus, and systems may combine user feedback with demographic information and/or profile information to identify personal preferences for properties. This not only includes more generic information such as neighborhood preference, price range preference, square footage preference, and/or bed/bath preference, this also includes more personal preference information such as identifying key words and/or images that are likely to engage the user. For example, the example methods, apparatus, and systems may determine that a user's home preference is primarily based on a home office setup and having a gourmet-level kitchen. In response to this determination, the example methods, apparatus, and systems are configured to arrange the virtual property tour to start with home office and kitchen information. Further, the example methods, apparatus, and systems may select information about a home office and kitchen details in a property description and/or other sections of a virtual property tour to ensure such features are highlighted to the user. In other words, the example methods, apparatus, and systems may highlight or showcase different features of the same property to different buyers based on determined personal preferences, thereby improving user engagement and chances that an offer is made.

In light of the present disclosure and the above aspects, it is therefore an advantage of the present disclosure to provide a virtual home tour application that obtains real time or near real time feedback of a property to enable a listing agent to target potential buyers who are most likely to purchase the property.

It is another advantage of the present disclosure to provide a dynamic property tour application that personalizes property information for a user based on determined user preferences.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE DRAWINGS

FIG. 1 is a diagram that is illustrative of a property tour system including a tour creation server, according to an example embodiment of the present disclosure.

FIG. 2 shows another embodiment of a property tour system including the tour creation server, according to an example embodiment of the present disclosure.

FIG. 3 is a flow diagram of an example procedure for creating a property tour using the tour creation server of FIG. 1 or 2, according to an example embodiment of the present disclosure.

FIG. 4 is a diagram of a room classification performed by the tour creation server using images provided by an agent, according to an example embodiment of the present disclosure.

FIG. 5 is a diagram of property features that were classified by the tour creation server for a Living Room, according to an example embodiment of the present disclosure.

FIG. 6 is a diagram of a room description created by the tour creation server, according to an example embodiment of the present disclosure.

FIG. 7 is a diagram of a user interface that enables an agent to specify property tour access information, according to an example embodiment of the present disclosure.

FIG. 8 is a flow diagram of an example procedure for personalizing a property tour, according to an example embodiment of the present disclosure.

FIG. 9 is a diagram of an application for displaying property tours, according to an example embodiment of the present disclosure.

FIGS. 10 to 18 are diagrams of user interfaces provided by the application of FIG. 9 for displaying property tours, according to an example embodiment of the present disclosure.

FIGS. 19 to 21 are diagrams of user interfaces showing user feedback from property tours, according to an example embodiment of the present disclosure.

### DETAILED DESCRIPTION OF THE INVENTION

Methods, apparatus, and systems are disclosed herein for providing and using feedback from virtual property tours to identify most likely prospective buyers for a property. The methods, apparatus, and systems disclosed herein take advantage of the fact that individuals who attend open houses love giving their opinion. This is a fundamental aspect of human nature. However for open houses, attendees usually provide feedback verbally to a listing agent after walking through the property. Oftentimes the listing agent is conversing with multiple individuals, which makes recording the feedback difficult. After an open house, an agent mentally recaps their interactions to provide feedback to the property seller. In addition, the agent uses their recollections to try and identify the most likely buyers.

Current known methods are imprecise and inefficient in obtaining feedback and identifying the top prospective buyers. Agents' recollection of feedback may be biased based on personal preferences for some individuals and/or biased based on feedback that conforms or confirms an agent's own beliefs. These biases may distort the feedback an agent gives to a buyer, and may negatively affect an ability to sell a property. Furthermore, agents may be identifying the wrong top prospective buyers, potentially losing valuable time in obtaining an offer.

The example methods, apparatus, and systems disclosed herein solve at least some of the above-issues by providing a digital/virtual experience for viewing a property. The digital/virtual experience is configured to prompt user feedback during a property tour. The feedback from multiple users is aggregated to provide unbiased feedback to a listing agent and a property seller. The collected feedback also helps automatically identify top prospective buyers for a listing agent to follow up after an open house.

In some embodiments, the example methods, apparatus, and systems are configured to use a rules based algorithm and/or machine learning to identify personal preferences of a user. The methods, apparatus, and systems are configured to personalize the virtual property tour based on the determined personal preferences so that property features that are most important to a user are highlighted. This personalization may include selecting certain terms, phrases, or descriptions displayed during a virtual property tour that align with preferred property features of a user. This may also include ordering a sequence of property rooms based on which ones are deemed most important to the user. Based on feedback provided by a user through the virtual property tour, the example methods, apparatus, and systems rank viewed properties that are most favorable to a user. The methods, apparatus, and systems may also use the feedback to determine property recommendations for properties that most closely match highly rated properties viewed by a user.

Reference is made herein to a virtual property tour. The examples disclosed herein are provided in reference to a virtual property tour shown via an application (e.g., an app) or a web browser. It should be appreciated that a virtual property tour is not limited to these mediums. In other examples, the virtual property tour may be provided using a virtual reality headset. In such examples, the property renderings shown in the virtual system may be interactive. For example, a user may manipulate features shown in the virtual system, such as household items including closing curtains or activating lights to change a lighting appearance. In some examples, the virtual reality system may include a tool for a user to leave feedback via, for example, marking virtually property features they like and property features they do not like. In a specific example, the virtual system may provide a marker that enables a user to virtually draw a circle or checkmark on features they like and an ‘X’ or other indication on features they do not like.

Reference is made herein to user characteristic and/or profile information. As disclosed herein, user characteristic and/or profile information includes any information that is related to a user that may be determined or otherwise received by the methods, apparatus, and systems disclosed herein. The user characteristic and/or profile information may be collected by monitoring property-related web browsing information (e.g., reading cookies on a user's web browser or monitoring interaction with a real estate web page/app), may be entered by a user during a registration process, and/or may be obtained from public records, such as property transaction information. The user characteristic and/or profile information may also include third-party variable data sources such as credit scores, employment status (e.g., information from a LinkedIn® profile or company webpage), and/or social media information. In some examples, the user characteristic information may include real estate search and/or browsing information including information indicative of a viewed neighborhood, zip code, or town in addition to residence type (e.g., home, apartment, condominium, etc.), listing/purchase price, square footage, property features (e.g., pet friendly, pool, garage, single-level, etc.) and/or area features (e.g., parks, public transit, schools, shopping, freeway access, etc.). The user characteristic may also include user state information (e.g., home ownership journey information) which is indicative as to whether the user is a first-time buyer, a second time buyer, a new owner, a mid-term owner, a long-term owner, a renter, an owner-renter, an investor, and/or a seller.

### I. Property Tour System

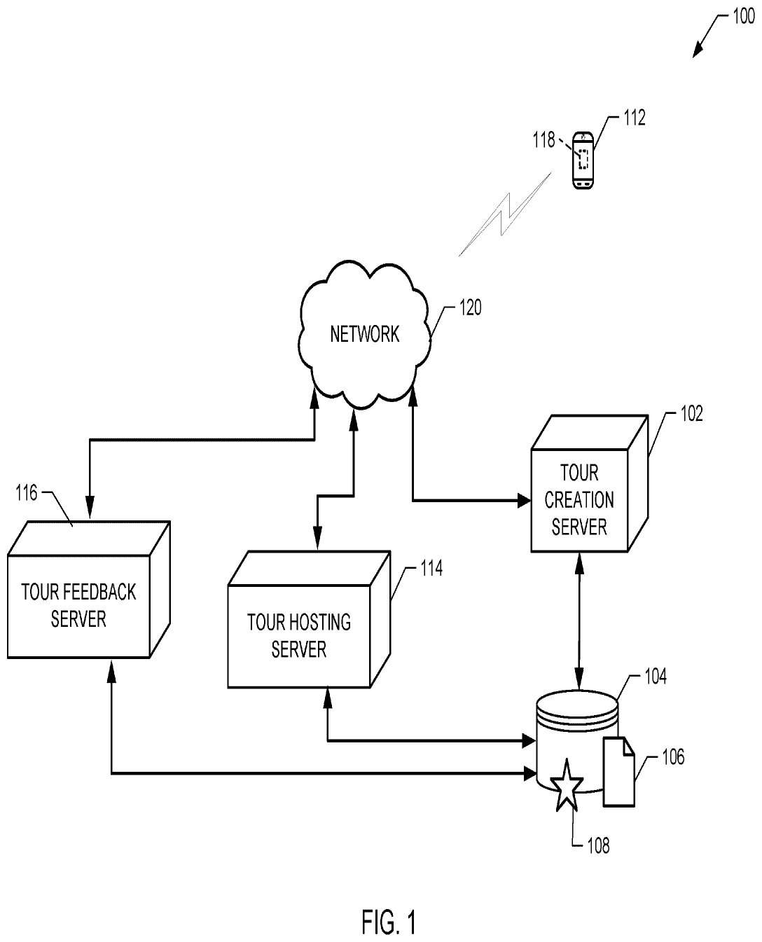

FIG. 1 is a diagram of an example property tour system 100, according to an example embodiment of the present disclosure. The example system 100 includes a tour creation server 102 that is communicatively coupled to a memory device 104. The tour creation server 102 may include a server, a cloud computing or distributive computing system, a workstation, a computer, a controller, a logic circuit, etc. The memory device 104 may include any flash or solid state data storage device including random access memory (“RAM”), read only memory (“ROM”), electrically erasable programmable read-only memory (“EEPROM”), a solid state drive (“SSD”), a hard disk drive (“HDD”), etc.

The example memory device 104 includes one or more computer-readable instructions. Execution of the one or more computer-readable instructions by the tour creation server 102 enables the tour creation server 102 to perform the operations described herein. Further, the one or more instructions may define one or more interfaces (e.g., application programming interfaces (“APIs”)) to enable an agent user (e.g., a listing agent) to create a property tour.

The memory device 104 is configured to store one or more property tours 106. Each property tour 106 may be stored as a data structure, file, record, etc. As described herein, a virtual property tour 106 includes at least one of audio, two-dimensional images, three-dimensional images, a video, an interactive image/video, text, and/or animated features that convey information about a property. The virtual property tour 106 may include one or more floor plans of a property.

In some embodiments, the floor plan may be linked or otherwise associated with GPS coordinates, terrestrial beacon coordinates, and/or other identifying information. In these embodiments, each room or area may be associated with coordinates or other identifying information to provide higher spatial resolution. In some instances, the virtual property tour 106 may include a rendering of a floor plan that links coordinates and distances to property features and/or rooms. For example, first GPS or terrestrial coordinates or a range/set of coordinates are associated with a first room and second GPS or terrestrial coordinates or a range/set of coordinates are associated with a second room.

As described herein, the example memory device 104 may also store a user profile 108 for users that view one or more virtual property tours 106. Each user profile 108 includes user characteristic and/or profile information comprising, for example, property transaction information, property-related browsing information, demographic information, and/or buyer preferences. The property transaction information includes data that is indicative of property transfer between a buyer and a seller. The property transaction information may include a transaction date, buyer names, seller names, a purchase price, and/or a property address or identification number. The property transaction information may further include rental information for a user, such as a rental address, a monthly rent, etc.

The property-related browsing information includes data that is indicative of a user's interaction with one or more web sites and/or virtual property tours that relate to property information. The property-related browsing information may include real estate searches conducted through a real estate search engine, properties viewed through a real estate website, and/or properties viewed through a virtual property tour. In these instances, the property-related browsing information may include neighborhood property data that is indicative of property addresses, neighborhoods of properties viewed/searched, an average list/sale property price, an average property transaction price, an average property square footage, an average year built, a distance from public transportation, a public school ranking, an average distance from a body of water, an average distance from a city center, and/or median property type.

The property-related browsing information may also include additional information that relates to property ownership. For example, the property-related web browsing information may include information related to browsing mortgage or refinancing information, information related to home services (e.g., landscaping, handyman, snow removal, decorating, maid service, etc.), information related to renovation, information related to property improvements/fixes, and/or information related to property restoration. The property-related browsing information may be obtained via cookies or other web usage tracking features on a user device 112. Alternatively, the property-related browsing information may be obtained via linked user accounts from a real estate web server. Further, the property-related browsing information may be obtained via app usage monitoring on the user device 112.

The example property tour system 100 of FIG. 1 also includes a tour hosting server 114 and a tour feedback server 116. As disclosed herein, the tour hosting server 114 is configured to provide virtual property tours 106 located in the memory device 104 to an application 118 (e.g., an app or web browser) on the user device 112. In some embodiments, the tour hosting server 114 is configured to personalize a virtual property tour 106 based on a user profile 108. Personalization may include arranging a sequence of images, video, and/or audio based on which rooms or property areas are deemed more important to the user, as specified in the user profile 108. Personalization may also include creating property description text that appeals to the user based on information specified in the user profile 108.

Personalization may also include sequencing a property tour based on which rooms are more important to a user. In this instance, the tour hosting server 114 ranks which rooms are most important to a user and then uses a floor plan of a property to create a path through the property such that the most important rooms are viewed first. The tour hosting server 114 then modifies the virtual property tour 106 such that rooms are sequenced based on the created path. The tour hosting server 114 may also provide room-by-room directions to guide a user along the created path.

In an example of personalization, the user profile 108 may specify that a user has a keen interest in quartz countertops and fine grained wood trim. Using this information in the user profile 108, the tour hosting server 114 identifies information and/or images of the virtual property tour 106 that relate to countertops and wood trim. If there is information indicative of quartz countertops and/or fine grained wood trim, the tour hosting server 114 populates this information into an overall listing description that is displayed when the virtual property tour 106 begins, thereby capturing the user's attention. The tour hosting server 114 may also display an icon or other indication in images that show countertops and/or wood trim to highlight such features. Selection of the icon causes additional text about the countertop and/or wood trim to be displayed.

The example tour feedback server 116 is configured to receive user feedback via the application 118 regarding property features of the virtual property tour 106. Feedback includes, for example, property features that a user prefers or does not like. Property features can include fixtures, such as appliances, countertops, cabinets, window treatments, etc. Property features can also include wall color, room shape, room size, layout, etc. The example virtual property tour 106 is configured to enable a user to provide virtually any type of feedback regarding the property.

In some embodiments, the application 118 is configured to record a length of time a user has spent viewing a room. For in-person property tours, the application 118 may start a timer each time a user enters a new room (detected using GPS and/or dead reckoning signals relative to a property layout) and/or browses a displayed room personally or using the user device 112. The application 118 may stop the timer when it is detected that the user has left the room or starts browsing another room. For virtual property tours, the application 118 is configured to record an amount of time a user views each room using the user device 112 before transitioning to the next room.

The application 118 is configured to aggregate a user's time looking at each room during the property tour. The application 118 may record a number of different instances that a user viewed a room, providing further feedback regarding a user's potential interest. The application 118 may further aggregate a total time viewing the property, either virtually and/or in-person. The application 118 is configured to transmit the length of time each room (and the property generally) was viewed to the feedback server 116, which uses this information to determine which rooms/features interested a buyer and/or to determine a buyer score (discussed in more detail below).

The tour feedback server 116 is configured to aggregate feedback from multiple users that toured the same property to identify which users are most likely buyers of the property. As described herein, the tour feedback server 116 uses feedback from each user to determine their interest. The tour feedback server 116 may also use a respective user profile 108 stored in the memory device 104 to determine if the user is a likely purchaser. The tour feedback server 116 is configured to provide a ranked list for a listing agent and/or seller to target the most likely buyers.

The example tour feedback server 116 is also configured to aggregate feedback of multiple properties for each user. The tour feedback server 116 uses user feedback from each tour and/or the user profile 108 to determine which properties most closely match the user's preferences and/or desires. The tour feedback server 116 may also use the user feedback and/or the user profile 108 to determine property recommendations for other virtual property tours 106. To determine a recommendation, the tour feedback server 116 identifies which properties and/or property features received favorable feedback and searches for properties with similar features.

It should be appreciated that the tour feedback server 116 does not simply locate the closest matching properties to make recommendations. Instead, the disclosed tour feedback server 116 is configured to aggregate the property features across multiple properties that a user provided a favorable impression. The tour feedback server 116 also aggregates negative feedback. The tour feedback server 116 then identifies and/or ranks properties that have the most properties features that match the property features that are deemed favorable by the user and do not have property features that were deemed unfavorable by the user. This enables the tour feedback server 116 to provide recommendations that are not necessarily limited to neighborhoods or towns of properties already viewed. For example, the tour feedback server 116 may identify a property located three towns away that has at least many of the favorable property features of a user, thereby expanding their search landscape.

Feedback from the tour feedback server 116 is also used to update the user profile 108. As discussed above, the tour feedback server 116 aggregates property features that are favorable and unfavorable for a user. This aggregation is stored to the user profile 108. The aggregation may identify a property feature (e.g., kitchen countertops) and at least one user preference (e.g., material (granite, quartz, wood, etc.), island, peninsula, thickness, color, edges, etc.). The tour feedback server 116 also aggregates property details if the information is indicative of a certain preference for a neighborhood, property size, lot size, property type, price range, etc. The tour feedback server 116 accordingly builds a user profile 108 that accurately reflects what features in a property interest a user using feedback received in real time or near real time while the user is touring properties. The updating of the user profile 108 enables the tour hosting server 114 to later personalize the virtual property tours 106 for subsequent properties toured or viewed by the user.

The servers 102, 114, and 116 are communicatively coupled to the user device 112 via a network 120. The example network 120 may include any local area network, wide area network, cellular network, and/or combinations thereof. For example, the network 120 may include a wireless local area network, the Internet, and/or a cellular 5G or 6G network.

The user device 112 includes an application 118 configured to display or otherwise provide the virtual property tour 106 to a user. The application 118 is also configured to receive user feedback regarding the virtual property tour 106. The application 118 is defined by one or more instructions stored in a memory device of the user device 112. Execution of the one or more instructions by a processor of the user device 112 causes the user device 112 to perform the operations disclosed herein. The application 118 may include a mobile application, such as a real estate application. In other examples, the application 118 may include a web browser. In these other examples, the application 118 may include a plug-in application or active website feature of the web browser for displaying the virtual property tour 106. The application 118 may be installed by a user via an app store. Alternatively, a user visiting an open house may receive a text message with a link from a listing agent (or record an image of a QR code) to install the application 118 prior to touring the property.

As shown in FIG. 1, the user device 112 may be located in a remote location away from a property to be toured. In these embodiments, the application 118 is configured to detect using GPS, for example, that the user device 112 is not located in a vicinity of a property selected to be toured. The application 118 accordingly is configured to display a remote version of the virtual property tour 106. In a remote version, the application 118 may show one or more floor plans that enables a user to navigate the different rooms of a property provided in the virtual property tour 106. Selection of a room or area causes the application 118 to access the corresponding information and/or display features of the virtual property tour 106 corresponding to the selection.

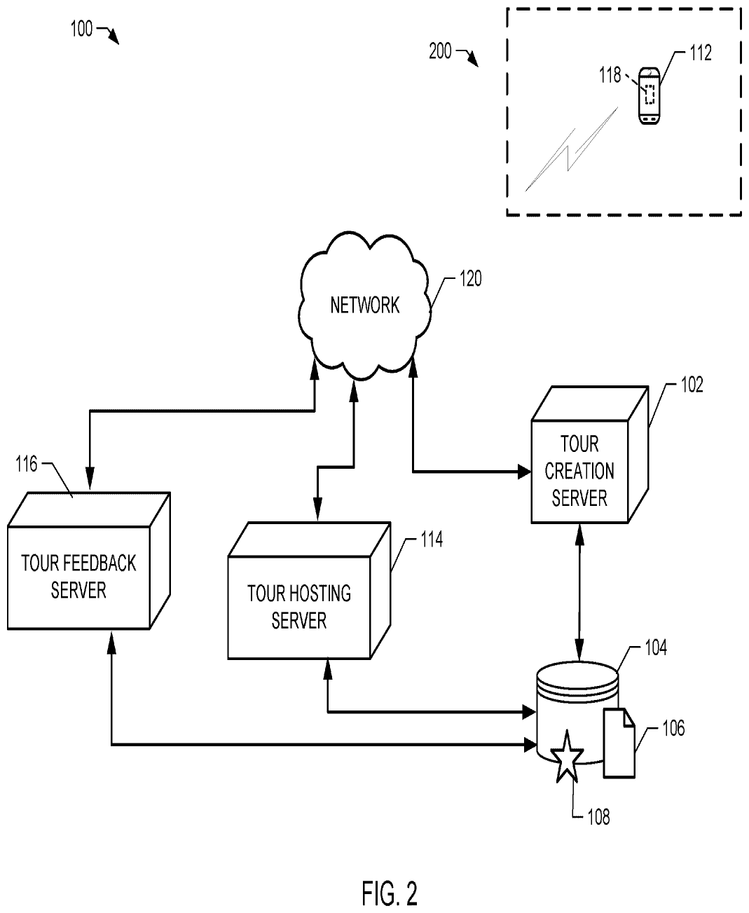

FIG. 2 shows another embodiment of the property tour system 100, according to an example embodiment of the present disclosure. In this example, the application 118 is configured to detect that the user device 112 is located at a property 200 to be toured. The application 118 may compare GPS signals of the user device 112 to specified GPS coordinates defined within the virtual property tour 106. If there is a match or overlap between the GPS coordinates, the application 118 determines that a guided property tour may be provided. In some instances, the application 118 may use one or more terrestrial beacon signals installed at the property 200 to determine that a guided tour is to be provided.

In some embodiments, the application 118 is configured to provide a guided tour by directing a user to move to property rooms and/or areas in a defined, sequential manner. Once in a room, the application 118 receives an input from the user to display information regarding the room. Alternatively, the application 118 may receive an indication that a user wants to move to a next room, and the application 118 displays information for the next room in the sequence.

In alternative embodiments, the application 118 may use GPS, terrestrial beacon signals, and/or dead reckoning information (e.g., acceleration and/or inertial sensor outputs) to determine a location of the user device 112 relative to the property 200. In these examples, the property tour 106 may include floor plan(s) with coordinates or a range of coordinates, distance, and/or orientation information. The application 118 is configured to track a user's movement with respect to the one or more floor plan(s). The application 118 detects a user is entering a room or area and accordingly displays property information from the virtual property tour 106 for that room or area. In some instances, the application 118 may determine a heading or orientation of the user device 112 using, for example, dead reckoning sensor outputs, to determine which information is to be displayed or otherwise conveyed to the user. In an example, the application 118 may detect that a user is looking or standing right in front of a kitchen countertop. In response, the application 118 causes information about the countertop to be displayed. In this manner, the application 118 turns the user device 112 into a pointer, where a user only has to align or point the user device at a property feature to receive more information, as programmed into the virtual property tour 106. In some instances, the application 118 may use the user profile 108 to determine to which locations as user should be directed to and/or determine which property features should be highlighted using, for example, a virtual path through the property that is created in conjunction with the virtual property tour 106. The application 118 and/or the tour host server 114 may create the virtual path using, for example, the information within the virtual property tour 106 and/or the user profile 108.

### II. Property Tour Creation Embodiment

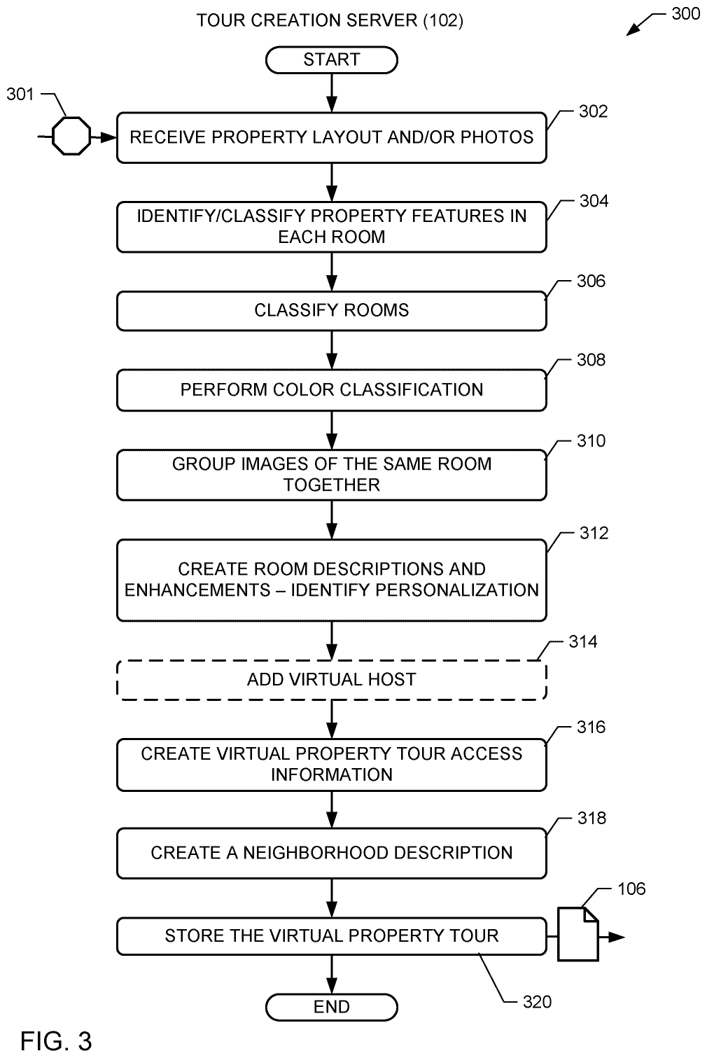

FIG. 3 is a flow diagram of an example procedure 300 for creating a virtual property tour 106, according to an example embodiment of the present disclosure. Although the procedure 300 is described with reference to the flow diagram illustrated in FIG. 3, it should be appreciated that many other methods of performing the steps associated with the procedure 300 may be used. For example, the order of many of the blocks may be changed, certain blocks may be combined with other blocks, and many of the blocks described may be optional. In an embodiment, the number of blocks may be changed based on information to be included or modified in the virtual property tour 106. The actions described in the procedure 300 are specified by one or more instructions that are stored in the memory device 104, and may be performed among multiple devices including, for example, the tour creation server 102, the tour hosting server 114, the tour feedback server 116, and/or the application 118.

The example procedure 300 begins when the tour creation server 102 receives an indication that a new virtual property tour is to be created. This includes receiving at least one floor layout, text, and/or images/video 301 related to the property (block 302). The tour creation server 102 then identifies and/or classifies property features in each image (block 304). The tour creation server 102 uses the property feature classifications to classify rooms (block 306). In other embodiments, the tour creation server 102 receives the room and/or property feature identification from an operator.

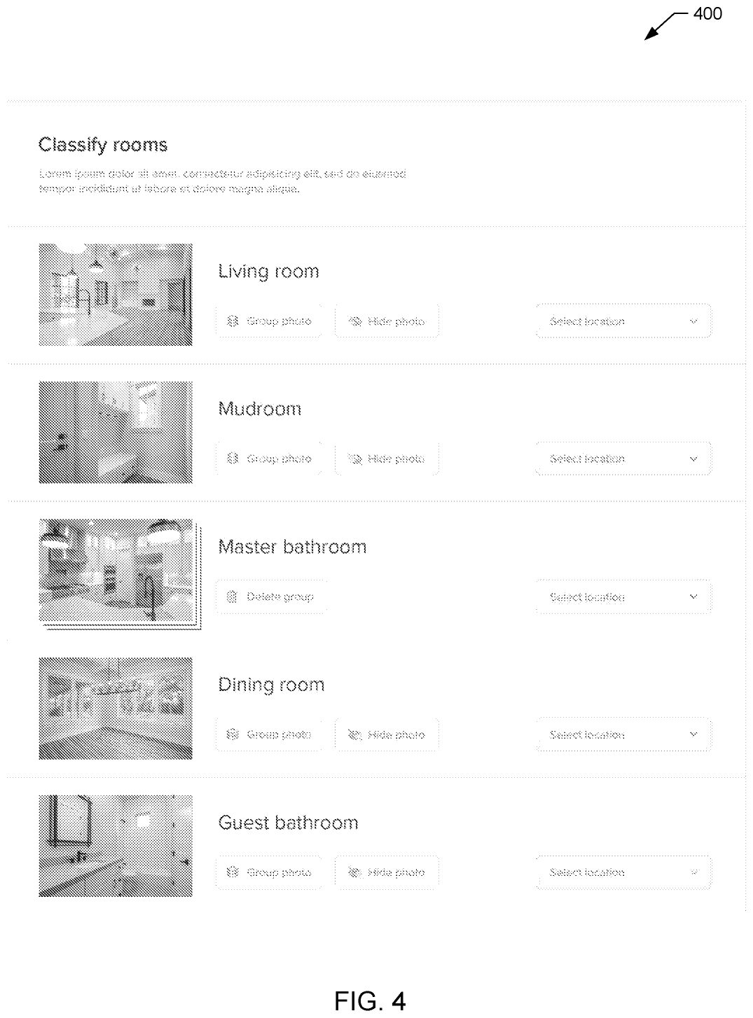

Rooms are classified using the characteristics within the room, which may then be verified by an agent. Room classifications can include Living Room, Dining Room, Kitchen, Grand (Living) Room, Den, Family Room, Office, Bedroom, Master Bedroom, Garage, Bathroom, Master Bathroom, Walk in Closet, Laundry Room, Attic, Basement, Workshop, Wine Cellar, Sun Room, Patio, Loft, etc. Room classification may also be determined for a floor level. In some embodiments, the classification of property features and/or rooms may be performed by a machine learning algorithm that is executable on the tour creation server 102. The machine learning algorithm may use a training data set in which certain rooms and/or property features are tagged or otherwise identified by a human. The property features and rooms are transmitted to the memory device 104 for creating a training model. In an example, the training model may receive hundreds of pictures of labeled kitchens, bathrooms, and bedrooms. The training model determines image properties common among the data set, such as kitchens having cabinets, large counters, and appliances, while bedrooms include beds, desks, window treatments, etc. Similar processing may be performed to identify the individual property features shown in each image, such as countertops, appliances, rugs/carpet, wood floors, built in furniture, molded ceilings, wainscoting, etc. The classifications created from the training model are used by the tour creation server 102 to classify the property features and/or rooms. In some embodiments, property features and/or rooms are classified to a confidence level, where the tour creation server 102 is configured to select a description based on the greatest confidence level. FIG. 4 is a diagram of a room classification 400 performed by the tour creation server 102 using images 301 provided by an agent. In the illustrated example, a “Select Location” feature provided by the tour creation server 102 enables an agent to link a classified room to a location on a floor layout. In other embodiments, the tour creation server 102 automatically uses room dimensions, identified locations of doors/windows, and/or other property features to associate a room with a corresponding location on a floor layout.

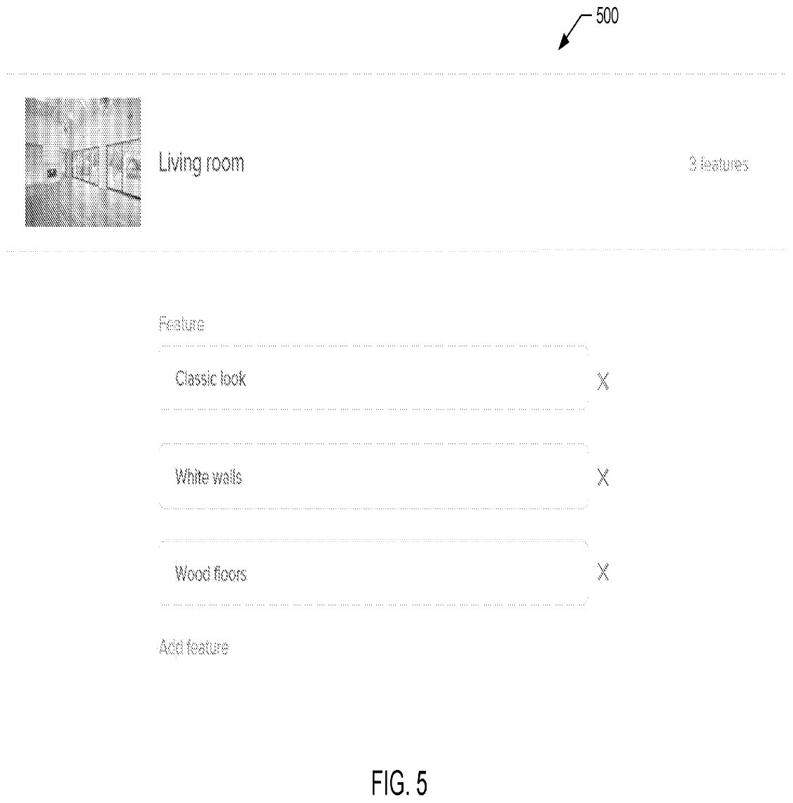

FIG. 5 is a diagram of property features 500 that were classified by the tour creation server 102 for a Living Room. The identified property features 500 include a ‘classic look’, ‘white walls’, and ‘wood floors’. The illustrated user interface 500 of FIG. 5 enables the agent to add additional property features that may not have been automatically classified.

As shown in FIG. 5, the tour creation server 102 may identify certain colors in the images 301. Returning to FIG. 3, after performing the room classification, the tour creation server 102 performs a color classification (block 308). The color classification may include a color data point. The tour creation server 102 may run pixels associated with each feature through a color classifier. The output is a color that has a closest similarity to the colors represented in the pixel of the image. The tour creation server 102 adds the output as an augmented data point to the room/property feature, as shown in FIG. 5. In an example, the tour creation server 102 may determine a ‘Himalayan Pink’ color for a granite countertop property feature.

Returning to FIG. 3, the tour creation server 102 next groups the images 301 of the same room together (block 310). To identify images 301 of the room, the tour creation server 102 is configured to partition each image of a room into a defined number of squares. The squares have a correlation coefficient based off the colors represented on their borders to a certain pixel density. The squares are then matched by the tour creation server 102 against squares from other images to determine a confidence level match against the square. The square borders are then matched by the tour creation server 102 against other image square borders to determine a confidence level match against an image. The property features represented within an image and the corresponding colors are then also matched by the tour creation server 102 against other images to determine a confidence level. The tour creation server 102 then combines the factors listed above with certain weights to determine if an image for a room is similar to a different image from that same room.

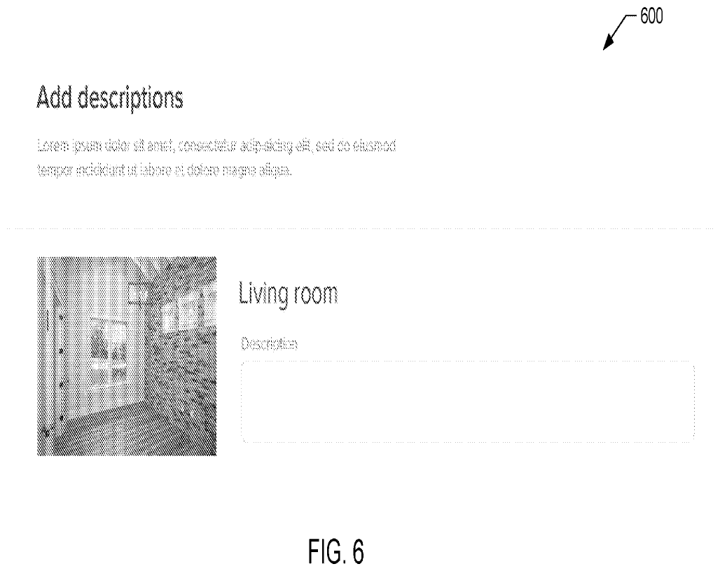

The tour creation server 102 then uses the room, property feature, and/or color classifications to create room and/or property descriptions (block 312). The tour creation server 102 may also identify sections of the property tour 106 in which personalization may be provided based on a user profile 108. In an example, the tour creation server 102 may create a description for a living room, as shown in a user interface 600 shown in FIG. 6. The tour creation server 102 selects at least some property features associated with the living room and/or any color or quality information. The tour creation server 102 may use a natural language algorithm that creates sentences for the property features, colors, and/or qualities. For example, the natural language algorithm is configured to create descriptions that convey a curated′ museum-like experience, such as the placards displayed next to paintings in a museum. In some instances, a text-to-audio algorithm may create an audio file for each room and/or property feature. Further, the tour creation server 102 may add interactive elements to certain images.

An agent may edit the description as needed. In some embodiments, the tour creation server 102 is configured to mark or indicate which property features may be added to a description based on a user profile 108. Alternatively, the tour creation server 102 may create metadata or keywords for rooms, property features, colors, etc., which are used by the tour host server 114 for matching to information in a user profile 108 for personalization.

In some embodiments, the tour creation server 102 auto-enhances room images 301 to augment certain property features and/or appearances. The tour creation server 102 may use an image processor that determines the colors represented in the image for each pixel (similar to operations performed for image classification and room grouping). The tour creation server 102 may group together pixels within an image that land in the same color band by assigning colors from a color database. The tour creation server 102 may then apply a sharpness effect to each pixel of an image, where each pixel is continuously split into additional pixels, which then carry the same characteristics of the non-split pixel. The tour creation server 102 may also apply a contract effect for each image for each color up to a certain threshold applied to the image from the image processor. For example, red, green, and blue may have a color up threshold of 128. Additionally, the image is run through a color process that creates a 20% pixel border in which a vignette effect is added to the image to highlight a center of the image.

Returning to FIG. 3, the tour creation server 102 next provides an option to add a virtual host (block 314). The virtual host or graphical animation may include a three-dimensional rendering of an agent, a picture of the agent, or an avatar. The virtual host may be configured to announce the audio information determined earlier. Further, the virtual host or graphical animation may be configured to move around an image to highlight certain property features.

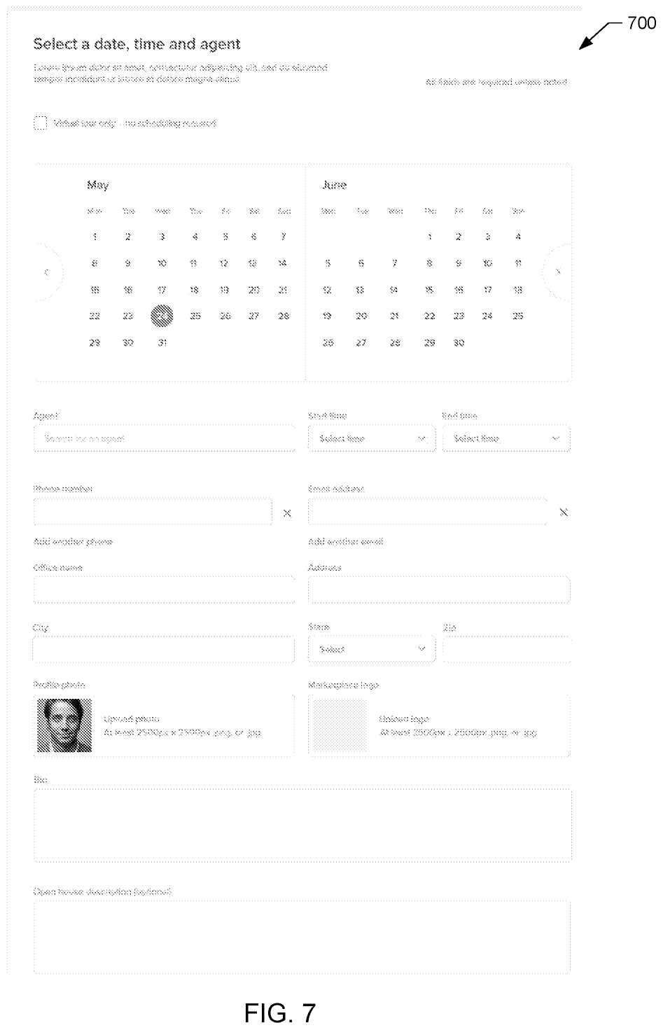

The tour creation server 102 also enables an agent to create property tour access information (block 316). FIG. 7 is a diagram of a user interface 700 that enables an agent to specify property tour access information, according to an example embodiment of the present disclosure. The user interface 700 enables an agent to specify a fixed time in which the property tour 106 is available, which may correspond to one or more open houses. The user interface 700 also has options that indicate how physical attendees are recorded, including an hourly time slot and calendar day in which a user visited the property. In some embodiments, the user interface 700 enables an agent to specify which version of a home tour 106 is to be provided remotely and which version is to be provided to an in-person attendee. In other embodiments, the tour creation server 102 creates separate versions. For instance, a remote version may provide a selectable floor plan or provide an automated guided tour. In contrast, an in-person version may enable a user to select a room, provide a guided tour consistent with walking through a property, and/or may track a user's location in the property to determine content of the property tour 106 for presentation.

The tour creation server 102 may also add neighborhood description information (block 318). As shown in FIG. 7, a specified address or a location of a property is used by the tour creation server 102 to access neighborhood information (including images or video) from the memory device 104 and/or a third-party server. The neighborhood information may include neighborhood properties, such as school information, walkability information, public transit availability, and/or typical characteristics of residents. In some embodiments, the tour creation server 102 defines search criteria for a neighborhood. The neighborhood information may not be accessed until requested by the application 118 during the presentation of a virtual property tour 106. In these instances, the tour host server 114 may use the search criteria for pulling neighborhood information from third-party websites via one or more APIs.

The example procedure 300 continues by the tour creation server 102 storing the newly created virtual property tour 106 to the memory device 104 (block 320). It should be appreciated that the tour creation server 102 enables agents to upload a video, 3D tour, and/or interactive content for each room or property location for a complete virtual property tour 106. The video or interactive information may be stored separately in the memory device 104 and linked to the virtual property tour 106. In these instances, the video or interactive features may include an attribute or metadata for linkage to a particular room, an image, and/or a property feature. After storage of the virtual property tour 106, the example procedure 300 ends.

### III. Property Tour Personalization Embodiment

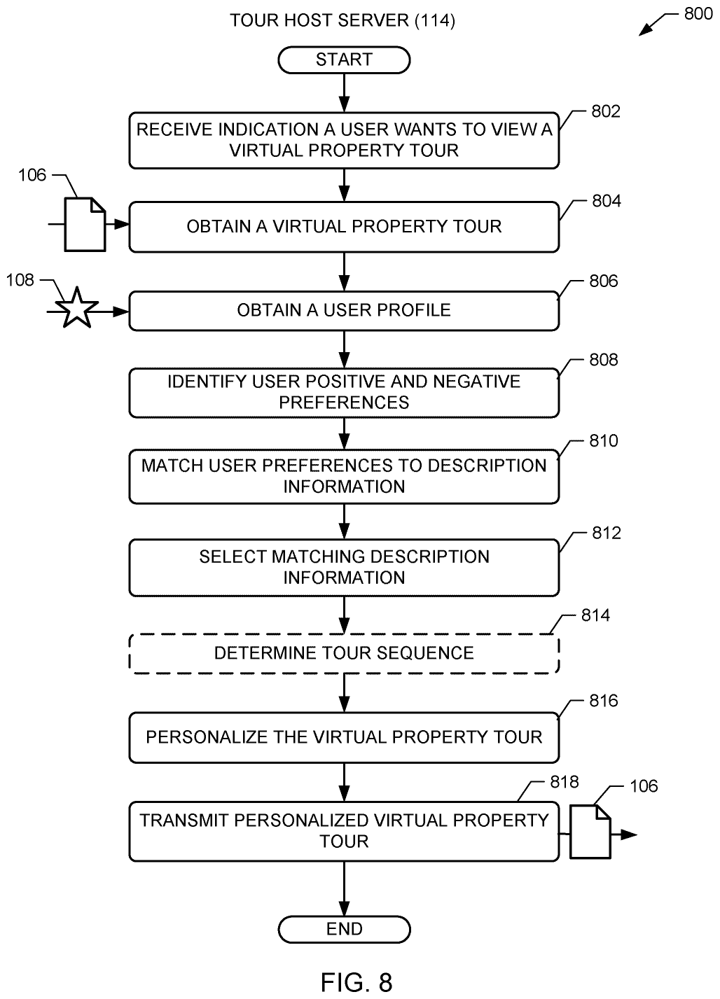

FIG. 8 is a flow diagram of an example procedure 800 for personalizing a virtual property tour 106, according to an example embodiment of the present disclosure. Although the procedure 800 is described with reference to the flow diagram illustrated in FIG. 8, it should be appreciated that many other methods of performing the steps associated with the procedure 800 may be used. For example, the order of many of the blocks may be changed, certain blocks may be combined with other blocks, and many of the blocks described may be optional. In an embodiment, the number of blocks may be changed based on which information is personalized for the virtual property tour 106. The actions described in the procedure 800 are specified by one or more instructions that are stored in the memory device 104, and may be performed among multiple devices including, for example, the tour creation server 102, the tour hosting server 114, the tour feedback server 116, and/or the application 118.

The procedure 800 begins when the tour hosting server 114 receives a message from the application 118 on the user device 112 that is indicative of a virtual property tour 106 selected by a user for viewing (block 802). The application 118 may display a list or map of properties with available property tours. Selection of a property causes the message to be transmitted by the application 118. After receiving the message, the tour hosting server 114 obtains a copy of the requested virtual property tour 106 from the memory device 104 (block 804). The tour hosting server 114 also obtains a copy of a user's profile 108 associated with the application 118 that transmitted the message (block 806).

In some embodiments, the message may also include a location of the user, such as GPS coordinates. In these embodiments, the tour hosting server 114 is configured to compare the location of the user to a location of the property associated with the virtual property tour 106. If the locations match or correspond, the tour hosting server 114 is configured to select and/or create an in-person version of the property tour 106 for personalization. However, if the locations do not match or are separated by at least ¼ of a mile, for example, the tour hosting server 114 is configured to select a remote version of the property tour 106 for personalization.

The tour hosting server 114 next identifies user positive and negative preferences that are aggregated in the user profile 108 (block 808). The tour hosting server 114 then compares or matches the user preferences to description information in the property tour 106 (block 810). If there is a match, the tour hosting server 114 selects text for a property feature description, room description(s), and/or property description(s) that match user favorable preferences. The tour hosting server 114 may use natural language processing to create sentences, as discussed above. Alternatively, the tour hosting server 114 may add the matching description to identified fields in a description section of the virtual property tour 106. When there is a match to the negative preferences, the tour hosting server 114 is configured to deemphasize, remove, or otherwise prevent the matching room and property descriptions from being included within the personalized virtual property tour 106.

In some embodiments, the tour hosting server 114 may also determine an image or tour sequence based on the preference matching (block 812). For example, a user may have preferences for outdoor space and a large master bathroom. After confirming the virtual property tour 106 includes images showing large outdoor space and a large master bathroom, the tour hosting server 114 creates a sequence where the outdoor space and master bathroom are shown first or at a beginning of a tour sequence. In some instances, the tour hosting server 114 is configured to create a tour sequence route or virtual path such that the top preferred rooms are shown, but still in a natural progression through a property, using for example, a floor layout for route planning where preferred rooms are identified as important or weighted waypoints. The tour hosting server 114 may create different sequences based on the in-person and remote versions of the virtual property tour 106.

After creating a sequence and adding a personalized description, the tour hosting server 114 recompiles a personalized version of the virtual property tour 106 (block 816). The tour hosting server 114 transmits the personalized version of the property tour 106 to the application 118 on the user device 112 (block 818). The example procedure 800 then ends.

### IV. Property Tour Application Embodiment

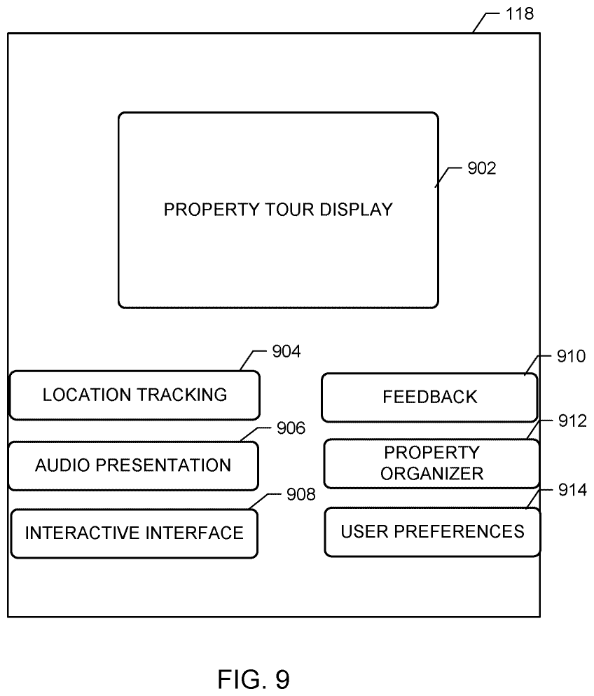

FIG. 9 is a diagram of the application 118 of FIGS. 1 and 2, according to an example embodiment of the present disclosure. As mentioned above, the application 118 may include a smartphone or tablet application or a web browser for a personal computer or laptop (e.g., the user device 112). FIG. 9 shows operations that may be embedded into the application 118 to provide the features discussed herein. It should be appreciated that the application 118 may include fewer or additional features.

The application 118 includes a property tour display engine 902, which is configured to display images, text, video, etc. of a virtual property tour 106. The property tour display engine 902 may also select which content of the virtual property tour 106 is selected for display based on a defined sequence.

A location tracking engine 904 of the application 118 is configured to identify a location of the user device 112. The location tracking engine 904 may use data from a GPS transceiver, terrestrial beacon transceivers, Wi-Fi signals, Bluetooth® signals, and/or dead reckoning signals to determine a location of a user. The location tracking engine 904 may be configured to determine a user location relative to a floor plan of a virtual property tour 106. In such an example, the floor plan may be coded with GPS, terrestrial, or other coordinates. A coordinate grid may be placed over a floor plan. Alternatively, certain coordinates or sets of coordinates are assigned to rooms or portions of rooms, such as entryways. The location tracking engine 904 compares the current user location to the coded coordinates to determine an approximate user location relative to the floor plan. In some embodiments, the location traction engine 904 may use dead reckoning sensor signals when a GPS signal cannot be received indoors to track how a user moves through a layout, which may be used by the tour display engine 902 for selecting which content is displayed. In some instances, data from terrestrial beacons is configured to be used by the location tracking engine 904 to determine a floor a user is located on or an elevation above ground level. Alternatively, atmospheric pressure data may be used by the location tracking engine 904 to determine height or elevation above ground, which is correlated to a particular floor.

The application 118 also includes an audio presentation engine 906 for providing audio of the property tour 106. The audio presentation engine 906 may play a separate or integrated audio file for each room, each property feature, or provide a continuous tour. An interactive interface engine 908 provides for control of interactive features of the property tour 106. This may include features for virtually changing a lighting level, closing window treatments, turning on a television or fireplace, turning on a shower, etc.

A feedback engine 910 is configured to obtain user feedback during viewing of the virtual property tour 106. Some virtual property tours 106 may include embedded icons, such as a check mark or an ‘X’. A user may select these icons to provide instant feedback regarding a property, a room, or a property feature, which is aggregated by the feedback engine 910. The feedback engine 910 may also include text fields to enable a user to provide more substantive feedback. The feedback engine 910 is configured to transmit the aggregated feedback to the tour feedback server 116 to update a user profile 108 and/or provide for aggregated feedback for a listing agent.

A property organizer engine 912 of the application 118 is configured to display a list or map of properties available for virtual property tours. The property organizer engine 912 may also enable a user to view already toured properties, including their previous feedback and a match score. A user preference engine 914 is configured to obtain user preferences before, during, and/or after a property tour. The user preference engine 914 may prompt a user for a current housing situation, a budget, demographic information, and/or personal property preferences, which are transmitted to the tour feedback server 116 to update the user profile 108.

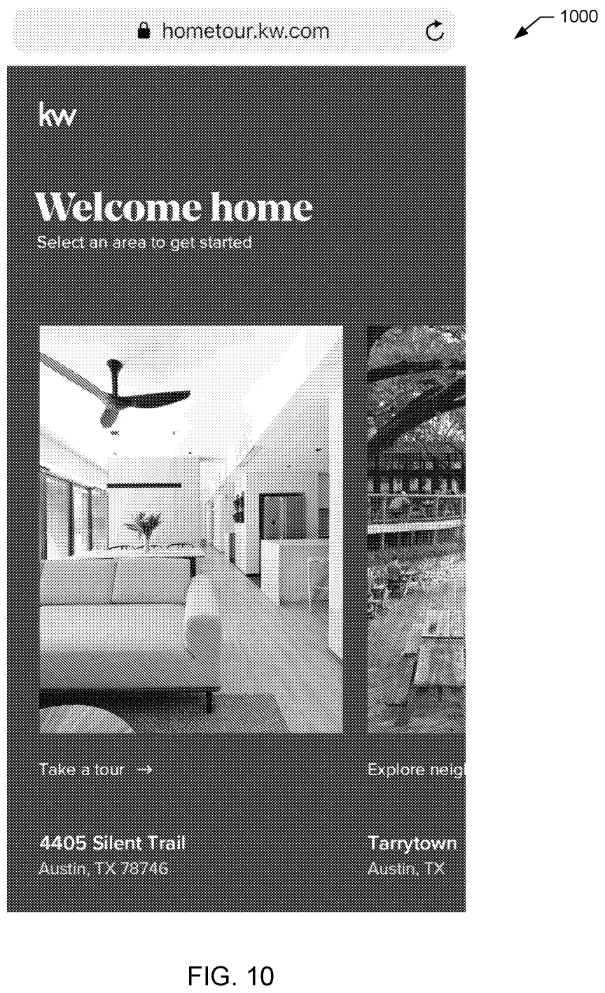

FIG. 10 is a diagram of a user interface 1000 showing a home page or landing page for a virtual property tour 106. In this example, a user has already used the application 118 to select a property. The user interface 1000 may show a parallax image of the property that was chosen by an agent or the server 102 to represent the tour. The application 118 may access the memory device 104 via the host server 114 to obtain the images, videos, and descriptions associated with virtual property tour 106 including the data associated with the neighborhood of the property.

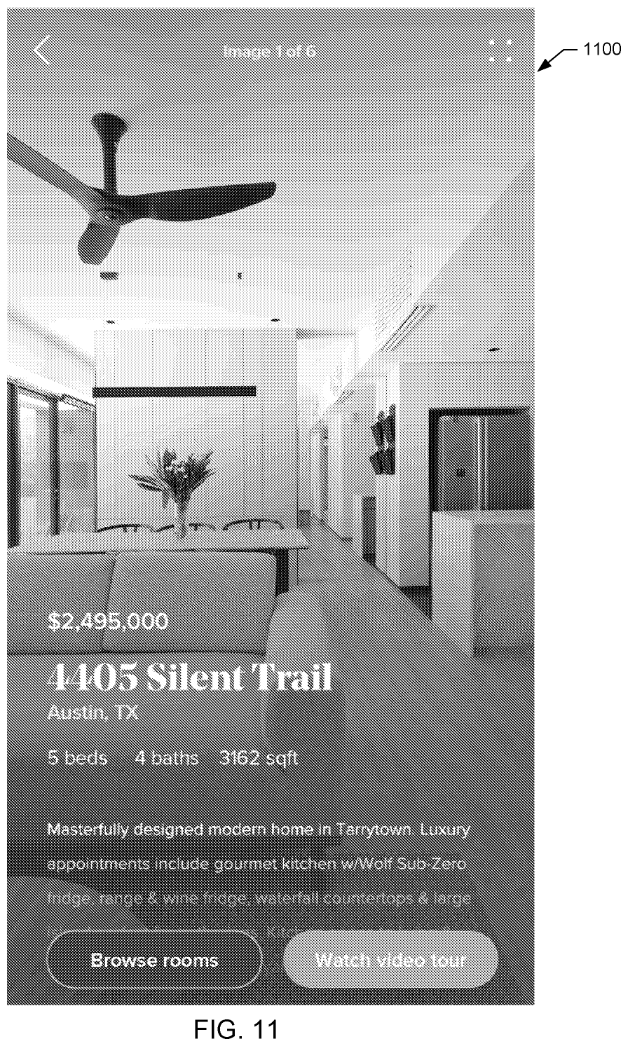

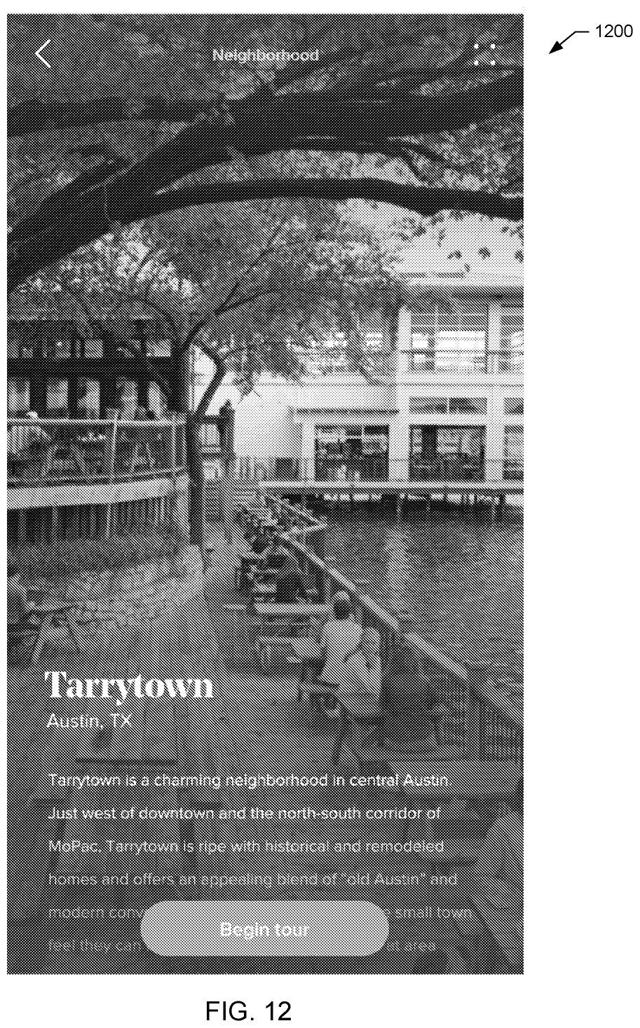

FIG. 11 is a diagram of a user interface 1100 showing options for a user to browse individual rooms or watch a guided tour. The text description shown in the user interface 1100 may be personalized for the user. Further, the guided tour may be passive for a remote version of the virtual property tour 106 and reactive based on a user's location for the in-person version. FIG. 12 is a diagram of a user interface 1200 for neighborhood information for the virtual property tour 106. The description may be personalized for the user. The server 114 may ping a third-party website to obtain the neighborhood information.

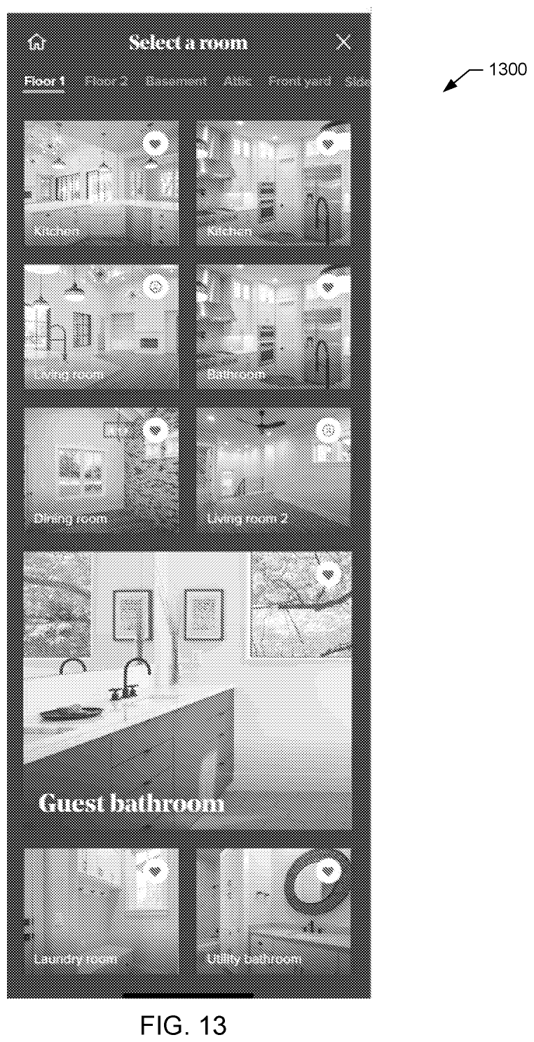

FIG. 13 is a diagram of a user interface 1300 that enables a user to select which room to view. While touring a room, the application 118 is configured to enable users to take pictures, rate whether or not they like or dislike the room, decide not to rate a room, and/or add comments. The application 118 transmits a user's feedback into a lead scoring mechanism of the server 116. Rooms may be weighted based on the characteristics associated with the user's profile 108. Rooms may also be weight based on a length of time a user spent viewing the room compared to a time spent viewing other rooms or the property generally. Each room has a specific weight that is applied up to a certain percentage of the overall match score based upon their profile 108 preference for each type of room. In an example, the server 116 provides a 12% weight for Dining Room vs 4% weight for Living Room against an overall lead scoring percentage match based on the user profile 108. Property features are sub-weighted against a room again based on the user's profile 108 preferences that apply to the lead scoring match percentage. In the above-example, the server 116 applies a 50% weight for the 12% Dining room (6% overall) for the recessed lighting versus 25% of the 12% Dining room (3%) being applied to the white-washed hard-wood floors. A percentage of each property feature is also sub-weighted against the sentiment provided by a user's feedback around that feature, if applicable. If not applicable, this scoring mechanism is skipped. The sentiment analysis is done by pinging the sentiment service of the server 116 to obtain a score around positive or negative sentiment. The % score is than applied to the weight. In this example, a Recessed Lighting sentiment had 75% positive sentiment. The overall weight for that feature would then have a multiplier that would be applied based off the percentage score, which in this case would be (0.75).

A non-response is initially recorded as a neutral weight (50%), while positive responses are initially recorded at 75% and negative responses are initially recorded at 25% before any multipliers are added to the weights for rooms. The weights are further changed based on time spent viewing a particular room (as detected by the application 118). Non-response weights increase from the original 50% based upon time spent on the screen for a particular room against the average time spent on that room for other users who have also toured that room. This includes whether the room does or does not have a video attached to the room description.

Users are also able to rate or not rate through the application 118 whether they like the features that have been classified by the system 100. A non-response is initially recorded as a neutral weight (50%), while positive responses are initially recorded at 75% and negative responses are initially recorded at 25% before any multipliers are added to the weights for rooms. Longer view times may be associated with a positive response and shorter view times may be associated with a negative response, especially for more prominent rooms such as the kitchen, living room, and master bedroom. Weights are then run through a sentiment multiplier of the server 116.

In some embodiments, the feedback server 116 is configured to calculate a buyer (match) score based on a number of instances a user has viewed a property. For example, a user may view a virtual property tour one day, perform an in-person tour another day, and perform another virtual property tour afterwards. The feedback server 116 is configured to account for these multiple visits, relative to other users, to determine whether a buyer should be assigned a greater match score.

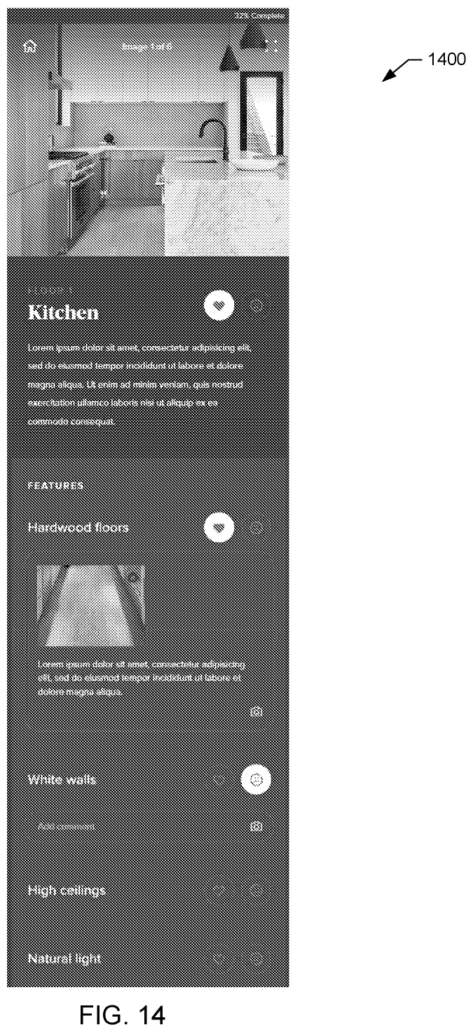

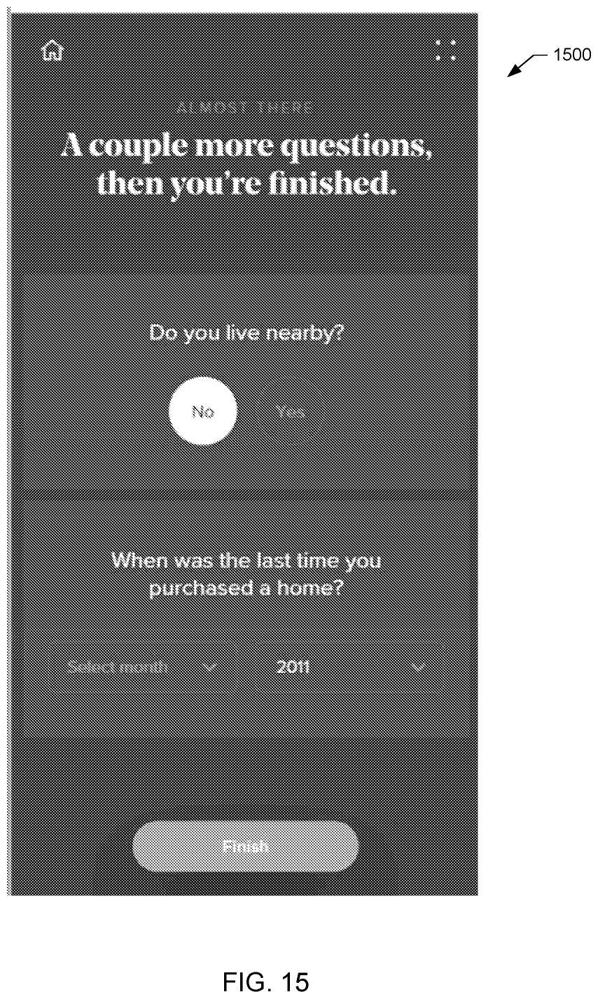

FIG. 14 shows a user interface 1400 of the application 118 in which a user has provided feedback regarding a kitchen and certain property features of the kitchen, which are scored and weighted, as discussed above. FIG. 15 shows a user interface 1500 of the application 118 in which the user is promoted with follow up questions after viewing the virtual property tour 106. The questions may include a year a user purchased their home and/or whether the user lives in the neighborhood. If the year purchased was 3 to 5 years or greater, for example, the user is classified by the server 116 as a seller. If the user lives in the neighborhood, they are classified by the server 116 as a seller. Additionally, the user may be classified as a prospective buyer. The responses above are not mutually exclusive. Thus if a response triggers a seller classification for the user based on a single question, the classification will not change based on the response of any other questions. The server 116 may also score-rank users against the current neighborhood they live in, the future neighborhood the sever 116 is predicting they will live in, and the similarity in terms of neighborhood financial characteristics, qualitative and quantitative characteristics, including but not limited to walkability, schools, and social characteristics.

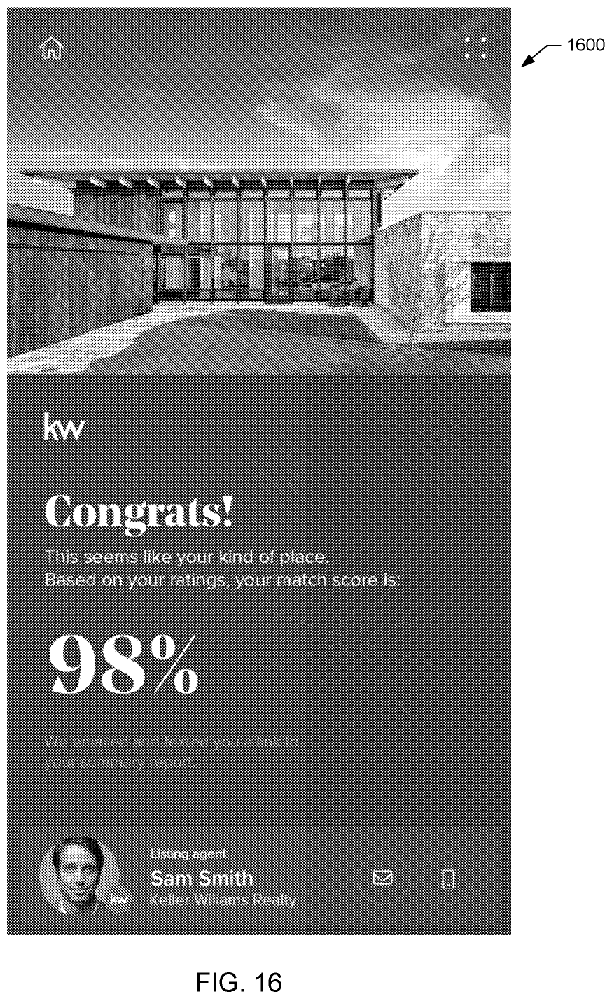

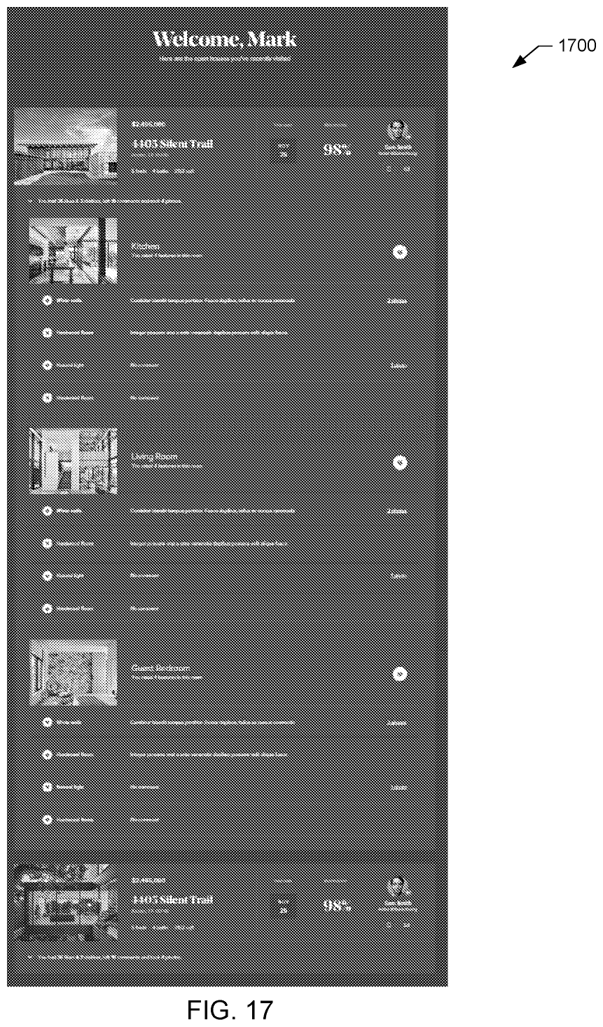

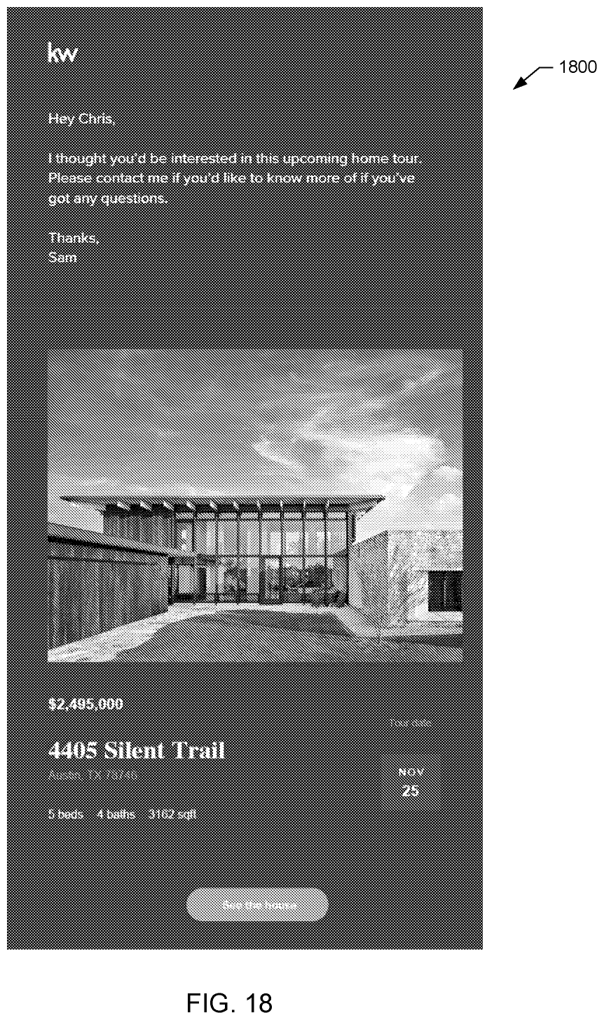

FIG. 16 shows a user interface 1600 after the user has completed the virtual property tour 106. The user interface 1600 includes a match score, calculated by the server 116, as discussed above. FIG. 17 shows a user interface 1700 of all the properties that a user has toured, including their feedback. Each property includes a feedback report including a date the property was toured, property features liked/disliked, rooms liked/disliked, and/or recommendations. FIG. 18 shows a user interface 1800 of a recommendation determined by the feedback server 116 based on the user's profile 108.

### V. Agent Feedback Embodiment

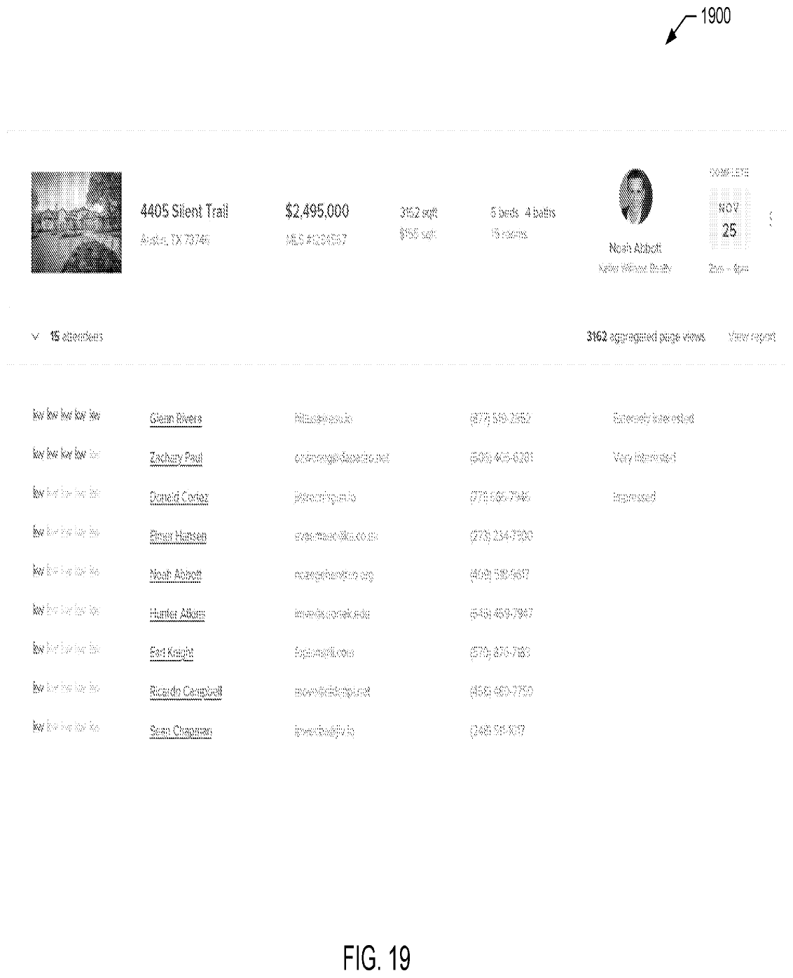

As discussed above, the tour feedback server 116 of FIGS. 1 and 2 is configured to aggregate feedback from users who have viewed a virtual property tour 106 of a particular property. The aggregation includes users who have viewed the property in person and remotely. FIGS. 19 to 21 are diagrams of user interfaces 1900 to 2100 showing user feedback from the property tours, according to an example embodiment of the present disclosure.

FIG. 19 shows a user interface 1900 that displays a match percentage for each user, including contact information, as determined from the user profile 108. The user interface 1900 may include examples of superlatives provided by the user through their feedback. The user interface 1900 may also indicate when each user accessed the virtual property tour 106. In some instances, using the info mentioned above, the user interface 1900 may indicate whether the user is classified as a buyer or potential seller.

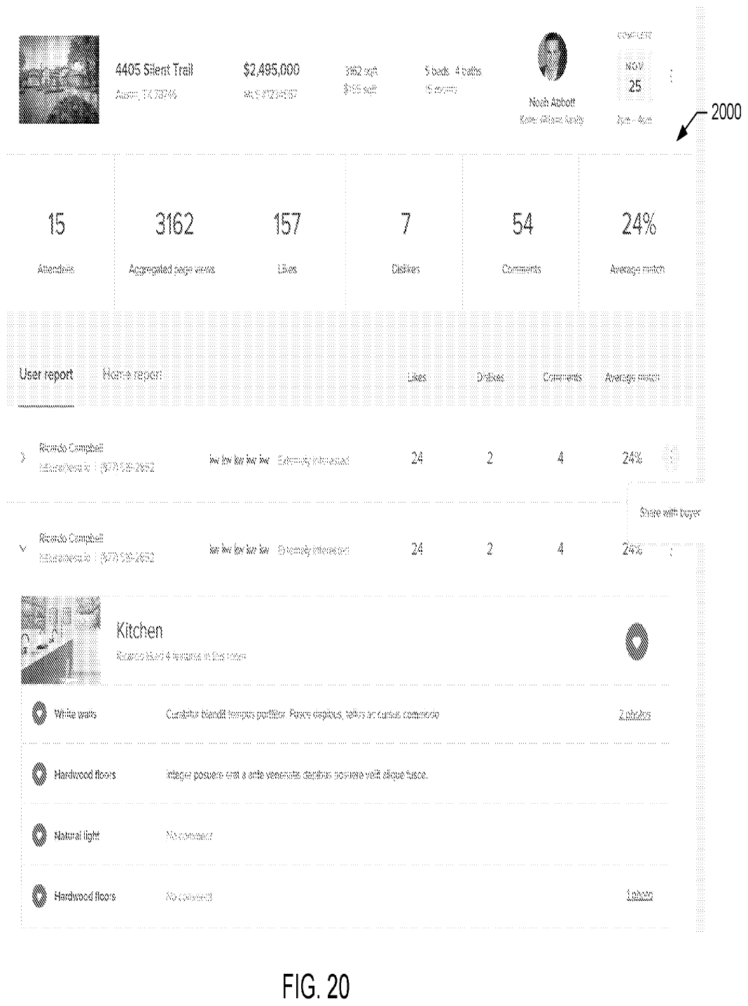

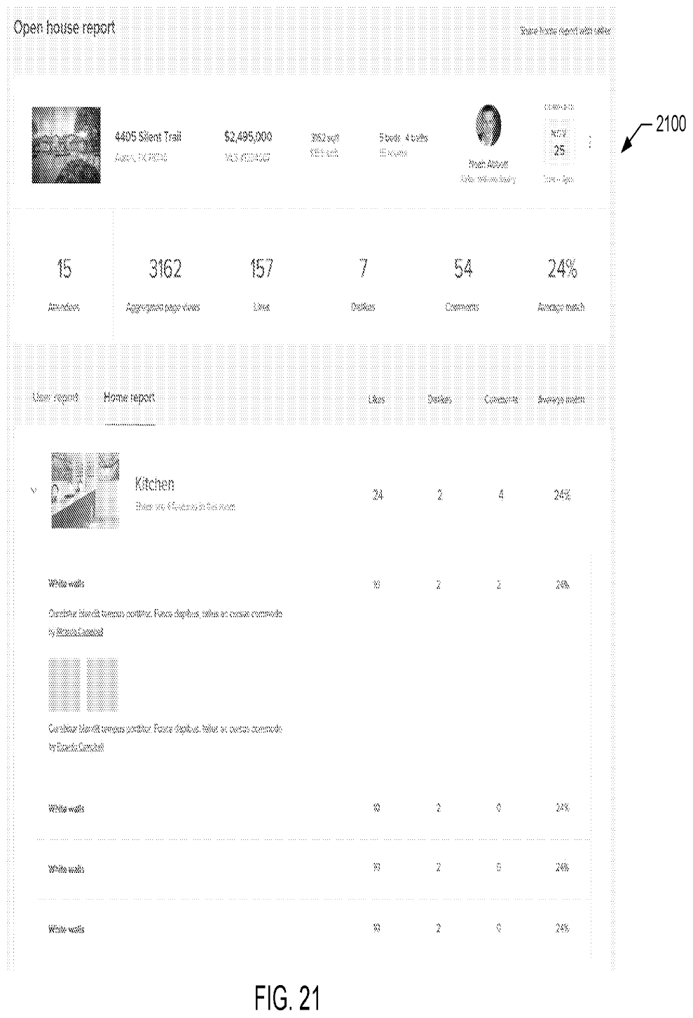

The user interface 2000 of FIG. 20 shows ratings and comments provided by different users. The ratings and comments are organized by property generally, then by room and individual property features. The interface 2000 may also include comments for each property feature provided as feedback and/or any pictures recorded by a user. Information in the user interface 200 may be shared with a seller, which may be used for changing or improving a property to address more negative comments. The user interface 2100 of FIG. 21 provides a summary for all users regarding likes/dislikes, comments, and an average match score for each property, room, and/or property feature, as calculated by the tour feedback server 116. The user interfaces 1900 to 2100 accordingly provide unbiased feedback to a seller and/or listing agent to ensure the most likely prospective buyers are engaged.

In some embodiments, a user interface may display a viewing time for each prospective buyer and/or an indication of a number of instances a property was toured virtually or physically. The agent may use this information to determine which buyers are still interested in a property if they periodically view a virtual property tour. Further, the agent may use the time/room information to show a seller which rooms are drawing the most and least interest. In some embodiments, the tour creation server 102 and/or the server 114 may update an order of images of rooms and/or descriptions to focus on rooms/features that correspond to greater viewing times.

### VI. Conclusion

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method for personalizing a virtual property tour for a user, the method comprising:
preparing a user profile for the user that includes user characteristics and profile information;
providing that is capable of storing a virtual property tour of a first property and the user profile, the first virtual property tour comprising a plurality of images of the first property and text relating to aspects of the property; and
a determining the user has selected to view the first virtual property tour via a message from a user computing device,
using the user profile of the user to modify a sequence for the room images and the text to personalize the first virtual property tour,
transmit the personalized virtual first property tour to the user computing device using a communication network;
viewing the personalized first virtual property tour using the user computing device;
while the user is viewing the personalized first virtual property tour on the user computing device, collecting first feedback from the user using the user computing device, wherein the feedback is in the form of at least one of text, audio and video;
while the user is viewing the personalized first virtual property tour on the user computing device, collecting second feedback from the user using the user computing device based upon a length of time that the user views particular images of the first property;
transmitting the first feedback and the second feedback from the user computing device to the server using the communications network;
using the server, modifying the first virtual property tour based upon the first feedback and the second feedback;
based upon the first feedback and the second feedback, providing a recommendation to the user for a second property to conduct a second virtual property tour;
modifying the second virtual property tour based upon the first feedback and the second feedback to produce a personalized second virtual property tour; and
transmitting the personalized second virtual property tour to the user computing device using the communications network.

2. The method of claim 1, wherein the first virtual property tour further comprises a property layout that includes location coordinates or a range/set of coordinates and the message includes a current location of the user device, and
wherein the method further comprises:
determining the current location of the user device corresponds to the location coordinates or the range/set of coordinates of the property layout, and
transmitting an in-person version of the personalized virtual property tour to the user device.

3. The method of claim 2, wherein the method further comprises:
creating an ordered list of rooms or property features most relevant to the user; and
creating a virtual path through the property such that at least some of the higher listed rooms or property features are viewed at a beginning of personalized virtual property tour.

4. The method of claim 2, wherein the property layout includes location coordinates or the range/set of coordinates for rooms of the property, and
wherein the method further comprises displaying at least one of the room images, the property features for the rooms, or the room and property descriptions for a specific room responsive to receiving coordinates that match or correspond to the location coordinates or the range/set of coordinates for the specific room.

5. The method of claim 2, wherein the method further comprises:
the current location of the user device does not correspond to the location coordinates or the range/set of coordinates of the property layout; and
personalized virtual property tour for transmission to the user device.

6. The method of claim 1, wherein the method further comprises:
using at least the user profile and information associated with the virtual property tour to create an ordered list of rooms or property features most relevant to the user; and
creating the sequence for the virtual property tour based on the ordered list of rooms or property features most relevant to the user.

7. The method of claim 1, wherein the method further comprises using the user profile of the user to select or highlight text for the personalized virtual property tour.

8. The method of claim 1, wherein the method further comprises:
aggregating the user first feedback with other user feedback from other users;
ranking the user with the other users as most likely buyers based on the user first feedback, the other user feedback, and user profiles of the user and the other users; and
displaying the ranking for a listing agent.

9. The method of claim 1, wherein the message includes an identifier of a property that corresponds to the virtual property tour, and wherein the message is transmitted from a real estate website responsive to the user selecting an option to view the virtual property tour for the property.

10. The method of claim 2, wherein the first property features for the rooms and the room and property descriptions of the first virtual property tour are determined automatically from a machine learning algorithm using at least one of the room images and the property layout.

11. The method of claim 1, wherein the server is configured to method further comprises:
using the user profile to determine user positive and negative preferences;
comparing or matching the user positive and negative preferences to the room and property descriptions; and
when there is a match to the positive preferences, selecting the matching room and property descriptions for at least one of inclusion in the personalized virtual property tour or highlighting within the personalized virtual property tour.

12. The method of claim 11, wherein the method further comprises, when there is a match to the negative preferences, deemphasizing or removing the matching room and property descriptions for the personalized virtual property tour.

13. The method of claim 1, wherein the first virtual property tour includes audio related to the property features for the rooms or room and property descriptions.

14. The method of claim 1, wherein the first virtual property tour includes at least one interactive element within a room that enables a user to at least one of virtually change a lighting level, close a window treatment, turn on a television or fireplace, or turn on a shower.

15. The method of claim 1, and further comprising:
viewing the personalized second virtual property tour using the user computing device;
while the user is viewing the personalized second virtual property tour, collecting third feedback from the user in the form of at least one of text, audio and video using the user computing device;
while the user is viewing the personalized second virtual property tour, collecting second feedback from the user based upon a length of time that the user views rooms in the second property using the user computing device; and
using the third feedback and the fourth feedback to modify the personalized second virtual property tour.

16. A system for personalizing a virtual property tour for a user, the system including:
a memory device storing a virtual property tour and a user profile, the virtual property tour including at least one of a property layout comprising location coordinates or a range/set of coordinates, room images, property features for the rooms, room and property descriptions, or prompts for providing feedback; and
a server communicatively coupled to the memory device, the server configured to:
determine a user has selected to view the virtual property tour via a message from a user device, the message including a current location of the user device,
use the user profile of the user to select a sequence for the room images and text to personalize the virtual property tour,
determine the current location of the user device corresponds to the location coordinates or the range/set of coordinates of the property layout, and
transmit an in-person version of the personalized virtual property tour to the user device.

17. The system of claim 16, wherein the server is configured to:
determine the current location of the user device does not correspond to the location coordinates or the range/set of coordinates of the property layout; and
select a remote version of the personalized virtual property tour for transmission to the user device.

18. The system of claim 16, wherein the server is configured to:
use at least the user profile and information associated with the virtual property tour to create an ordered list of rooms or property features most relevant to the user;
create a virtual path through the property such that at least some of the higher listed rooms or property features are viewed at a beginning of personalized virtual property tour; and
create the sequence for the room images and text based on the virtual path.

19. The system of claim 16, wherein the property layout includes location coordinates or the range/set of coordinates for rooms of the property, and
wherein the personalized virtual property tour is configured to display at least one of the room images, the property features for the rooms, or the room and property descriptions for a specific room responsive to receiving coordinates that match or correspond to the location coordinates or the range/set of coordinates for the specific room.
